(19) United States
(12) Patent Application Publication
(10) Pub. No.: US 2008/0032116 A1
(43) Pub. Date: Feb. 7, 2008

(54) Organic Polymer Monolith, Process for Preparing the Same, and Uses Thereof

(76) Inventors: Ken Hosoya, Kyoto (JP); Kuniaki Shimbo, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 11/597,878

(22) PCT Filed: May 31, 2005
(86) PCT No.: PCT/JP05/10311

§ 371 Date: Nov. 29, 2006

Related U.S. Application Data
(60) Provisional application No. 60/578,844, filed on Jun. 14, 2004.

(30) Foreign Application Priority Data
May 31, 2004 (JP) 2004-161773

(51) Int. Cl. B32B 5/18; C08J 3/24; C08L 101/00

(52) U.S. Cl. 428/315.5; 525/374; 526/303.1; 526/317.1

(57) ABSTRACT

Disclosed is an organic polymer monolith comprising a monomer unit derived from a monomer having a hydroxyl group and/or an amide group in an amount of not less than 20% by mass, and/or a monomer unit derived from a crosslinking agent in an amount of not less than 50% by mass, having throughpores with a mode diameter, as measured by mercury porosimetry, of 0.5 to 10 mm and mesopores with a mode diameter, as measured by a BET method, of 2 to 50 nm, and having a specific surface area, as measured by a BET method, of not less than 50 m²/g. Also disclosed are a process for preparing the organic polymer monolith and a chemical substance separating device using the organic polymer monolith.

### CROSS-REFERENCE TO RELATED APPLICATIONS

This application is an application filed under 35 U.S.C. §111 (a) claiming benefit pursuant to 35 U.S.C. §119(e) (1) of the filing date of Provisional Application 60/578,844 filed Jun. 14, 2004 pursuant to 35 U.S.C. §111 (b).

### TECHNICAL FIELD

The present invention relates to an organic polymer monolith, a process for preparing the same and a chemical substance separating device using the same.

### BACKGROUND ART

As chemical substance separating devices, such as columns for chemical substance analysis (e.g., columns for liquid chromatography), columns (or cartridges) for chemical substance concentration and columns (or cartridges) for chemical substance removal, appropriate containers (e.g., columns, cartridges) filled with fillers such as porous spherical particles, crushed particles or fibers have been heretofore mainly employed. As the fillers, there are various types, such as silica gels, organic polymers, alumina, zeolite, hydroxyapatite, activated carbon and silicon carbide. Particularly as the columns for liquid chromatography, containers filled with porous spherical particles of silica gels or organic polymers have predominated.

In order to enhance separation performance of the chemical substance separating devices, any one of a method of increasing filling density and a method of decreasing a number-average diameter of a filler has been usually employed. In the former method, however, the filling density is not increased to such an extent as desired because of dispersion in shape or diameter of the filler, and in the latter method, the processing speed is liable to be limited because the burden of pressure on the column or the device is increased. In case of micropore columns or capillary columns having an inner diameter of not more than 1 mm, further, a dead volume of a frit that is necessary for holding the filler is liable to cause lowering of separation performance.

As a means to improve such inconveniences as mentioned above, a technique of forming a rod-like porous continuum (monolith) by in-column polymerization (polymerization in the presence of a diluent) is known. If the polymerization conditions are strictly controlled, a monolith having both of throughpores of μm sizes bearing security of flow rate and mesopores of nm sizes bearing mutual interaction with a chemical substance can be formed. By the use of such a monolith, it becomes possible to enhance separation performance without increasing a burden of pressure. Moreover, if the monolith and the inner surface of the column have good adhesion to each other or if a means to promote adhesion between them (e.g., covalent bond between inner surface and monolith) is taken when needed, even a frit becomes unnecessary.

As monoliths, a silica gel monolith (patent documents 1 and 2, non-patent documents 1 and 2) and a polymer monolith (patent documents 3 to 5, non-patent documents 2 to 8) have been studied, and a few columns for liquid chromatography using these monoliths as stationary phases are on the market. The former monolith is, for example, Chromolith™ (available from Merck AG) for reversed phase chromatography, and the latter monolith is, for example, Swift™ (available from Isco, Inc.) for ion exchange or reversed phase chromatography of protein.

Of the above monoliths, the silica gel monolith has disadvantages that the monolith tends to be decreased in the performance when used under the pH conditions of not more than 2 and not less than 9 and it is difficult to allow the monolith to have multifunctions without subjecting it to surface modification. In contrast therewith, the organic polymer monolith has an advantage that the monolith can be readily imparted with chemical stability (e.g., employable at pH of 1 to 13) and additional functions necessary for separation (e.g., control of hydrophobicity, ability of recognizing specific molecules) without subjecting it to surface modification because there are various types of monomers and polymerization processes employable for the synthesis of the monolith.

In the existing circumstances, however, the organic polymer monolith has more complicated relation between the synthesis conditions and the resulting pore structure as compared with the silica gel monolith, so that it is difficult to control sizes of throughpores and mesopores independently and with good reproducibility. For example, in order to efficiently separate low-molecular chemical substances having a molecular weight of not more than 1,000, it is necessary to form a great number of mesopores having a mode diameter of 2 to 50 nm to secure a specific surface area of not less than 50 m²/g and to sufficiently form throughpores having a mode diameter of 0.5 to 10 μm at the same time. However, it is very difficult to satisfy these requirements, and the requirements have been attained only under very few conditions in an organic polymer monolith that uses an aromatic monomer having extremely high hydrophobicity such as divinylbenzene or ethylstyrene in an amount of 88 to 100% by mass based on the total amount of monomers and in an organic polymer monolith that is formed by copolymerizing ethylene dimethacrylate (also referred to “ethylene glycol dimethacrylate”) and glycidyl methacrylate using the ethylene dimethacrylate (crosslinking agent) in an amount of not more than 40% by mass (non-patent documents 3 to 8).

However, if the aromatic monomer having extremely high hydrophobicity such as divinylbenzene or ethylstrene is used in an amount of more than 75% by mass based on the total amount of monomers, the aromatic low-molecular compound is too strongly adsorbed on the organic polymer monolith, and hence, when the organic polymer monolith is used as a column for liquid chromatography, delay or widening of a peak of a chromatogram frequently occurs, or when the organic polymer monolith is used as a cartridge for chemical substance concentration, efficiency of elution of the desired substance is frequently lowered. Moreover, the surface of the organic polymer monolith is hardly wetted with water, and hence, when the monolith is used as a cartridge for chemical substance removal, removal efficiency is sometimes lowered.

On the other hand, an example of a successful copolymer having moderate hydrophobicity formed from ethylene dimethacrylate and glycidyl methacrylate is limited to that formed by the use of ethylene dimethacrylate that is a crosslinking agent in an amount of not more than 40% by mass based on the total amount of monomers. Therefore, inhibition of swell-shrinkage of the resulting polymer becomes insufficient, and when the polymer monolith is used as a column for liquid chromatography, solvent exchange cannot be freely carried out. There is another example that uses trimethylolpropane trimethacrylate as a crosslinking agent having moderate hydrophobicity in an amount of not less than 70% by mass based on the total amount of monomers, but the requirements of a specific surface area of not less than 50 m²/g and a throughpore mode diameter of 0.5 to 10 μm have not been satisfied (non-patent documents 5 and 7).

Accordingly, an important problem to be solved for the practical use of the organic polymer monolith is to satisfy the above requirements (specific surface area of not less than 50 m²/g and throughpore mode diameter of 0.5 to 10 mm) for efficiently separating low-molecular chemical substances having a molecular weight of not more than 1,000 with adjusting the hydrophobicity in a desired range even when the amount of the crosslinking agent is increased to not less than 50% by mass.

Because of such circumstances as described above, use application of most of products which are reported or commercially available as usual columns for liquid chromatography using organic polymer monoliths as stationary phases is limited to separation of high-molecular substances having a molecular weight of more than 1,000, such as protein or polypeptide. No other organic polymer monoliths capable of efficiently separating low-molecular chemical substances having a molecule weight of not more than 1,000 than those having a specific type (for capillary electrochromatography) which utilize electro-osmosis flow in order to avoid a burden of pressure have not been realized yet. In the capillary electrochromatography, a larger number of theoretical plates are apt to be realized, but on the other hand, there is a restriction that an electrically conductive functional group must be necessarily introduced, and besides, there is a problem that reproducibility of performance between columns is hardly obtained. Therefore, such organic polymer monoliths are hardly adopted as general-purpose analytical means, and commercialization of columns is difficult.

Patent document 1: International Publication WO95/03256 pamphlet (U.S. Pat. No. 5,624,875)

Patent document 2: International Publication WO98/29350 pamphlet (U.S. Pat. No. 6,207,098)

Patent document 3: International Publication WO93/07945 pamphlet (JP-A-H07-501140)

Patent document 4: U.S. Pat. No. 5,334,310

Patent document 5: U.S. Pat. No. 5,453,185

Non-patent document 1: H. Minakuchi, et al. “Anal. Chem.” (U.S.A), 1996, Vol. 68, p. 3498

Non-patent document 2: H. Zou, et al. “J. Chromatogr. A” (U.S.A), 2002, Vol. 954, p. 5

Non-patent document 3: Jm. J. Frechet, et al. “Chem. Mater.” (U.S.A), 1995, Vol. 7, p. 707

Non-patent document 4: Jm. J. Frechet, et al. “Chem. Mater.” (U.S.A), 1996, Vol. 8, p. 744

Non-patent document 5: K. Irgum, et al. “Chem. Mater.” (U.S.A), 1997, Vol. 9, p. 463

Non-patent document 6: Jm. J. Frechet, et al. “Chem. Mater.” (U.S.A), 1998, Vol. 10, p. 4072

Non-patent document 7: A. B. Holmes, et al. “Adv. Mater.” (Germany), 1999, Vol. 11, p. 1270

Non-patent document 8: P. Coufal, et al. “J. Chromatogr. A” (U.S.A), 2002, Vol. 946, p. 99

### DISCLOSURE OF THE INVENTION

The present inventors have earnestly studied realization of an organic polymer monolith capable of efficiently separating chemical substances, particularly low-molecular chemical substances having a molecular weight of not more than 1,000, and they have judged that by the use of only the conventional techniques, it is extremely difficult to form an organic polymer monolith, which has a controlled pore structure that is necessary for enhancing separation performance without increasing a burden of pressure in the passing of liquid, which exhibits excellent performance of separation of aromatic low-molecular compounds and can freely carrying out solvent exchange when used as a column for liquid chromatography, which exhibits excellent elution efficiency when used as a cartridge for chemical substance concentration, and which exhibits excellent removal efficiency when used as a cartridge for chemical substance removal.

The present invention has been made in the light of such technical problems as mentioned above, and it is an object of the present invention to provide an organic polymer monolith capable of solving the above problems associated with the prior art.

It is another object of the present invention to provide a process for preparing the organic polymer monolith.

It is a further object of the present invention to provide a chemical substance separating device using the organic polymer monolith.

As a result of earnest studies, the present inventors could solve the above problems by the use of such an organic polymer monolith of the present invention as described below. In particular, the present inventors have found that an organic polymer monolith prepared by the use of a monomer mixture comprising a crosslinking agent (monomer having plural polymerizable functional groups) in an amount of not less than 50% by mass and a monomer having a hydroxyl group and/or an amide group (—CONH₂ and/or —CONH—) in an amount of not less than 20% by mass exhibits excellent effects.

That is to say, the present invention is as follows.

(1) An organic polymer monolith comprising a monomer unit derived from a monomer having a hydroxyl group and/or an amide group in an amount of not less than 20% by mass, having throughpores with a mode diameter, as measured by mercury porosimetry, of 0.5 to 10 μm and mesopores with a mode diameter, as measured by a BET method, of 2 to 50 nm, and having a specific surface area, as measured by a BET method, of not less than 50 m²/g.

(2) An organic polymer monolith comprising a monomer unit derived from a crosslinking agent in an amount of not less than 50% by mass, having throughpores with a mode diameter, as measured by mercury porosimetry, of 0.5 to 10 μm and mesopores with a mode diameter, as measured by a BET method, of 2 to 50 nm, and having a specific surface area, as measured by a BET method, of not less than 50 m²/g.

(3) The organic polymer monolith as stated in (1) or (2), which is prepared by polymerizing a monomer mixture in the presence of a diluent and a polymerization initiator, wherein:

the monomer mixture comprises a crosslinking agent in an amount of not less than 50% by mass and a monomer having a hydroxyl group and/or an amide group in an amount of not less than 20% by mass, based on the total amount of the monomer mixture, and

the diluent comprises a diluent having none of a hydroxyl group, an amide group and a carboxyl group, in an amount of not less than 85% by mass based on the total amount of the diluent.

(4) The organic polymer monolith as stated in (1) or (2), which is prepared by polymerizing a monomer mixture in the presence of a diluent, a polymerization initiator and a non-crosslinking polymer, wherein:

the monomer mixture comprises a crosslinking agent in an amount of not less than 50% by mass and a monomer having a hydroxyl group and/or an amide group in an amount of not less than 20% by mass, based on the total amount of the monomer mixture.

(5) The organic polymer monolith as stated in (4), wherein the diluent comprises a diluent having none of a hydroxyl group, an amide group and a carboxyl group, in an amount of not less than 85% by mass based on the total amount of the diluent.

(6) The organic polymer monolith as stated in (4) or (5), wherein the non-crosslinking polymer is polystyrene.

(7) The organic polymer monolith as stated in any one of (1) and (3) to (6), wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

(8) The organic polymer monolith as stated in any one of (3) and (5) to (7), wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

(9) A process for preparing the organic polymer monolith as stated in any one of (1) to (8), comprising a step of polymerizing a monomer mixture in the presence of a diluent and a polymerization initiator, wherein:

the monomer mixture comprises a crosslinking agent in an amount of not less than 50% by mass and a monomer having a hydroxyl group and/or an amide group in an amount of not less than 20% by mass, based on the total amount of the monomer mixture, and

the diluent comprises a diluent having none of a hydroxyl group, an amide group and a carboxyl group, in an amount of not less than 85% by mass based on the total amount of the diluent.

(10) A process for preparing the organic polymer monolith as stated in any one of (1) to (8), comprising a step of polymerizing a monomer mixture in the presence of a diluent, a polymerization initiator and a non-crosslinking polymer, wherein:

the monomer mixture comprises a crosslinking agent in an amount of not less than 50% by mass and a monomer having a hydroxyl group and/or an amide group in an amount of not less than 20% by mass, based on the total amount of the monomer mixture.

(11) The process as stated in (10), wherein the diluent comprises a diluent having none of a hydroxyl group, an amide group and a carboxyl group, in an amount of not less than 85% by mass based on the total amount of the diluent.

(12) The process as stated in (10) or (11), wherein the non-crosslinking polymer is polystyrene.

(13) The process as stated in any one of (9) to (12), wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

(14) The process as stated in any one of (9) and (11) to (13), wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

(15) A chemical substance separating device using, as a stationary phase, the organic polymer monolith as stated in any one of (1) to (8) or the organic polymer monolith having been surface modified.

(16) The chemical substance separating device as stated in (15), which is a column for liquid chromatography.

(17) The chemical substance separating device as stated in (15), which is a column for chemical substance concentration or a solid phase extraction cartridge for chemical substance concentration.

(18) The chemical substance separating device as stated in (15), which is a column for chemical substance removal or a solid phase extraction cartridge for chemical substance removal.

### EFFECT OF THE INVENTION

The organic polymer monolith of the present invention has a controlled pore structure, and therefore, by the use of the organic polymer monolith, chemical substances, particularly low-molecular chemical substances having a molecular weight of not more than 1,000, can be efficiently separated.

According to the process of the present invention, an organic polymer monolith having such excellent properties as mentioned above can be prepared.

By the use of the organic polymer monolith of the present invention, further, a chemical substance separating device which has a light burden of pressure in the passing of liquid, exhibits excellent performance of separation of aromatic low-molecular compounds and is capable of freely carrying out solvent exchange can be provided.

The chemical substance separating device of the present invention can be used as a column for liquid chromatography which exhibits excellent performance of separation of aromatic low-molecular compounds and is capable of freely carrying out solvent exchange, as a solid phase extraction cartridge for chemical substance concentration which exhibits excellent elution efficiency, or as a solid phase extraction cartridge for chemical substance removal which exhibits excellent removal efficiency.

### BRIEF DESCRIPTION OF THE DRAWINGS

FIG. 1 is a SEM photograph of a piece of a gel formed in Example 1 [GDMA+toluene].

FIG. 2 is a SEM photograph of a piece of a gel formed in Comparative Example 1a [GDMA+toluene+methanol].

FIG. 3 is a SEM photograph of a piece of a gel formed in Comparative Example 1b [EDMA+toluene].

FIG. 4 is a SEM photograph of a piece of a gel formed in Comparative Example 1c [HDMA+toluene].

FIG. 5 is a SEM photograph of a piece of a gel formed in Example 7 [GDMA+DVB monolith cartridge (diluent (toluene))+PS].

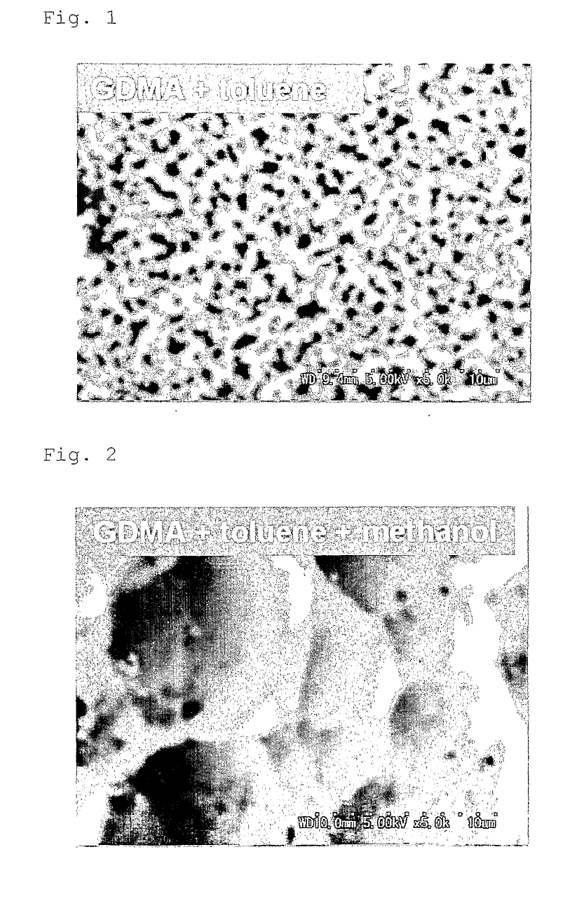

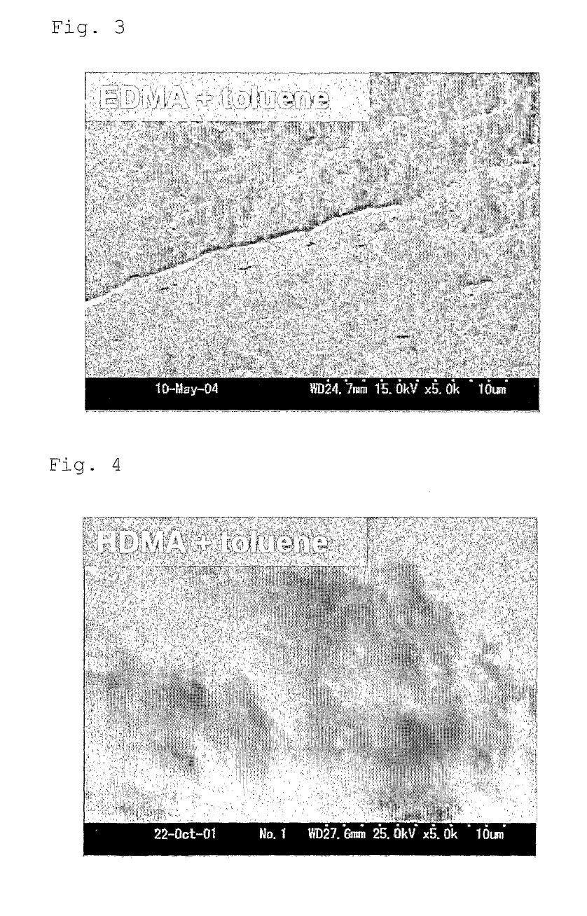

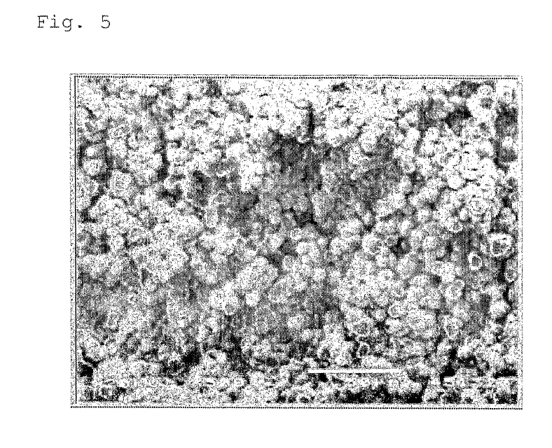

### BEST MODE FOR CARRYING OUT THE INVENTION

A mode to carry out the present invention is described in detail hereinafter.

### Organic Polymer Monolith

The monolith referred to herein is a rod-like porous continuum.

One organic polymer monolith of the invention comprises a monomer unit derived from a monomer having a hydroxyl group and/or an amide group (—CONH₂ and/or —CONH—) in an amount of not less than 20% by mass (with the proviso that the mass of the organic polymer monolith is 100% by mass), has throughpores with a mode diameter, as measured by mercury porosimetry, of 0.5 to 10 μm and mesopores with a mode diameter, as measured by a BET method, of 2 to 50 nm, and has a specific surface area, as measured by a BET method, of not less than 50 m²/g.

The other organic polymer monolith of the invention comprises a monomer unit derived from a crosslinking agent in an amount of not less than 50% by mass (with the proviso that the mass of the organic polymer monolith is 100% by mass), has throughpores with a mode diameter, as measured by mercury porosimetry, of 0.5 to 10 μm and mesopores with a mode diameter, as measured by a BET method, of 2 to 50 nm, and has a specific surface area, as measured by a BET method, of not less than 50 m²/g.

In the case where the hydroxyl group-containing monomer is, for example, glycerol dimethacrylate, the monomer unit derived from a monomer having a hydroxyl group and/or an amide group is the following unit. This glycerol dimethacrylate is also a crosslinking agent (monomer having plural polymerizable functional groups) described later in detail.

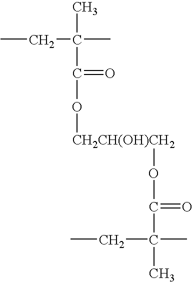

The content of the monomer unit that is derived from a monomer having a hydroxyl group and/or an amide group (—CONH₂ and/or —CONH—) and constitutes the organic polymer monolith of the invention is not less than 20% by mass, preferably not less than 40% by mass, more preferably not less than 50% by mass, based on 100% by mass of the organic polymer monolith. The content of the monomer unit can be controlled by controlling the amount of the monomer in the monomer mixture for use in the invention.

The throughpores referred to herein are macropores (throughholes) of μm size corresponding to gaps formed among the monolith skeletons, and the mesopores are a great number of micropores of nm size formed in the monolith skeletons. The mode diameter means a value of P that gives a maximum peak of the ordinate value in a pore size distribution curve obtained by measuring a pore diameter P and a pore volume V by mercury porosimetry or a BET method and plotting P as abscissa and ΔV/Δ (log P) as ordinate.

The mode diameter of the throughpores as measured by mercury porosimetry is in the range of 0.5 to 10 μm, preferably 1 to 8 μm, more preferably 1 to 6 μm. If the mode diameter of the throughpores is less than 0.5 μm, the burden of pressure tends to become heavy, and therefore, the processing rate tends to be hardly increased. If the mode diameter thereof is more than 10 μm, porosity of the monolith tends to become large, and therefore, physical strength of the monolith tends to be hardly maintained.

The mode diameter of the mesopores as measured by a BET method is in the range of 2 to 50 nm, preferably 2 to 40 nm, more preferably 3 to 30 nm. If the mode diameter of the mesopores is less than 2 nm, substances capable of entering the mesopores tend to be restricted, and therefore, performance of the monolith to separate chemical substances tends to be lowered. If the mode diameter thereof is more than 50 nm, the specific surface area is liable to be decreased, and therefore, the above-mentioned separation performance tends to be lowered.

The specific surface area of the organic polymer monolith as measured by a BET method is not less than 50 m²/g, preferably not less than 100 m²/g, more preferably not less than 200 m²/g. If the specific surface area is less than 50 m²/g, satisfactory separation performance tends to be hardly obtained.

### Process for Preparing Organic Polymer Monolith Polymerization

In the present invention, a monomer mixture is polymerized in the presence of a diluent, a polymerization initiator and a non-crosslinking polymer that is added when needed, whereby an organic polymer monolith is prepared. Through the above polymerization reaction, the organic polymer monolith is obtained as a bulk polymer, e.g., a gelated polymer (gelation product). This polymer (organic polymer monolith) undergoes phase separation from the diluent and is obtained in such a state that the diluent is left within the throughpores and the mesopores.

The polymerization in the invention is preferably carried out by filling a polymerization container with a solution or a suspension obtained by sufficiently mixing a monomer mixture, a diluent, a polymerization initiator and a non-crosslinking polymer that is added when needed. In the present invention, a crosslinking agent (monomer having plural polymerizable functional groups in a molecule) and a non-crosslinking monomer (monomer having one polymerizable functional group in a molecule) are together referred to as a “monomer mixture”.

The size, shape and material of the polymerization container are not specifically restricted, but taking it into consideration that it is advantageous to directly process the monolith into a chemical substance separating device after the polymerization without taking out the monolith, the polymerization container is preferably, for example, an empty column (made of stainless steel, polymer or glass) usually used for manufacturing a column for liquid chromatography or a column for gas chromatography, a piping tube (made of stainless steel or polymer), a capillary tube (made of fused silica gel), or an empty cartridge (made of polymer or glass) used for manufacturing a solid phase extraction cartridge for chemical substance concentration (or removal).

Both ends of the polymerization container filled with a solution or a suspension are usually closed before the polymerization. However, under the conditions such that the solution or the suspension does not solidify and remains at one or both ends at the time the polymerization of the necessary portion corresponding to the center or the lower part (part used as a chemical substance separating device after cutting of the end(s)) is completed, the ends of the container do not necessarily have to be closed because the liquid blocks the air. In case of, for example, thermal polymerization that is carried out in a water bath, it is possible that a lower end of a long and narrow pipe is closed and an open upper end thereof is allowed to come out from the water surface by several cm, or it is also possible that both of open ends of a U-shaped pipe or a flexible capillary tube are each allowed to come out from the water surface by several cm. Even when both ends of the polymerization container are closed, segmentalization of the monolith or poor adhesion between the monolith and the inner surface of the container can be prevented by performing thermal polymerization in such a state that an upper end or both ends of the container are intentionally allowed to come out from the water surface by several cm or by adding the solution or the suspension to an upper end or both ends of the container during the course of the polymerization. In case of photopolymerization, a portion of several cm at an upper end or both ends of the container may be masked so that it should not be exposed to light.

On the other hand, a means of taking out the monolith from the polymerization container by utilizing volume shrinkage brought about in the polymerization and inserting it into another container of suitable size closely or hardening the surface of the monolith with a resin may be adopted, and also in such a case, the ends of the container do not need to be closed during the polymerization.

### Monomer Mixture

### Crosslinking Agent

The crosslinking agent for use in the invention is a monomer having plural polymerizable functional groups in a molecule. The polymerizable functional group is preferably an ethylenic double bond. When the crosslinking agent has ethylenic double bonds in a molecule, two or more ethylenic double bonds have only to be present in a molecule of the crosslinking agent.

Examples of the crosslinking agents for use in the invention include (meth)acrylate type crosslinking agents, (meth)acrylamide type crosslinking agents and aromatic crosslinking agents. Taking it into consideration that as the intramolecular distance between functional groups participating in the crosslinking reaction is shortened, the effect of inhibiting swell-shrinkage of the resulting polymer becomes greater, preferable are glycerol dimethacrylate, ethylene dimethacrylate, trimethylolpropane trimethacrylate, methylenebisacrylamide, N,N′-(1,2-dihydroxyethylene)bis-acrylamide, divinylbenzene, triallyl isocyanurate and mixtures of two or more of these compounds. Of these, glycerol dimethacrylate, methylenebisacrylamide and N,N′-(1,2-dihydroxyethylene)bis-acrylamide are more preferable because they also have properties of the later-described monomer having a hydroxyl group and/or an amide group.

For the purpose of adjusting hydrophobicity of the organic polymer monolith of the invention to a desired one, other crosslinking agents can be appropriately employed. In order to increase hydrophobicity to the utmost, divinylbenzene is preferably employed.

The proportion of the crosslinking agent in the monomer mixture for use in the invention is preferably not less than 50% by mass, more preferably not less than 60% by mass, still more preferably not less than 70% by mass, based on the total amount 100% by mass of the monomer mixture. When the proportion of the crosslinking agent is in the above range, the effect of inhibiting swell-shrinkage of the resulting polymer is sufficiently exerted, so that such a proportion is preferable. In case of an aromatic crosslinking agent having extremely high hydrophobicity such as divinylbenzene, however, the proportion of the crosslinking agent is preferably not more than 75% by mass. For example, if divinylbenzene is used in an amount of more than 75% by mass, the aromatic low-molecular compound is too strongly adsorbed on the organic polymer monolith, and hence, delay or widening of a peak of a chromatogram frequently occurs when the organic polymer monolith is used as a column for liquid chromatography, or efficiency of elution of the desired substance is frequently lowered when the organic polymer monolith is used as a solid phase extraction cartridge for chemical substance concentration. Moreover, the surface of the organic polymer monolith is hardly wetted with water, and therefore, when the monolith is used as a solid phase extraction cartridge for chemical substance removal, removal efficiency is sometimes lowered.

### Monomer Having Hydroxyl Group and/or Amide Group

In the present invention, the throughpores can be formed by taking advantage of the fact that the space is partitioned by physical crosslinking that is caused by hydrogen bonding (referred to as “physical crosslinking due to hydrogen bonding” hereinafter) between the molecules or within the molecules of the polymer produced by the polymerization. In order to form the throughpores by utilizing the physical crosslinking due to hydrogen bonding, it is necessary that a monomer having a functional group capable of undergoing hydrogen bonding should be contained in the monomer mixture. A typical example of such a monomer is a monomer having a hydroxyl group and/or an amide group. The monomer having a hydroxyl group and/or an amide group may be a monomer different from the aforesaid crosslinking agent, namely, a non-crosslinking monomer (monomer having only one polymerizable functional group), or may be a monomer also having properties of a crosslinking agent (monomer having plural polymerizable functional groups).

Preferred examples of the monomers having a hydroxyl group and/or an amide group for use in the invention include glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene. Taking it into consideration that the monomer can contribute to inhibition of swell-shrinkage of the resulting polymer if the monomer also has a function of a crosslinking agent, more preferable are glycerol dimethacrylate, methylenebisacrylamide and N,N′-(1,2-dihydroxyethylene)bis-acrylamide. Taking into consideration an advantage that the organic polymer monolith is readily modified if the monomer has a hydroxyl group, still more preferable are glycerol dimethacrylate and N,N′-(1,2-dihydroxyethylene)bis-acrylamide. These monomers may be used singly or in combination of plural kinds.

The proportion of the monomer having a hydroxyl group and/or an amide group in the monomer mixture for use in the invention is preferably not less than 20% by mass, more preferably not less than 25% by mass, still more preferably not less than 40% by mass, especially preferably not less than 50% by mass, based on the total amount 100% by mass of the monomer mixture. When the proportion of the monomer having a hydroxyl group and/or an amide group is in the above range, the effect of forming throughpores in the organic monolith by the physical crosslinking due to hydrogen bonding is sufficiently exerted, so that such a proportion is preferable.

The monomer mixture for use in the invention has only to satisfy requirements that it comprises a crosslinking agent (monomer having plural polymerizable functional groups) in an mount of not less than 50% by mass and a monomer having a hydroxyl group and/or an amide group in an amount of not less than 20% by mass, based on the total amount (100% by mass) of the monomer mixture, but the monomer mixture may further comprise a monomer that is a non-crosslinking monomer and has none of a hydroxyl group and an amide group.

As such a monomer, for example, ethylstyrene, methylstyrene, chloromethylstyrene, glycidyl methacrylate, methyl methacrylate, butyl methacrylate, methacryloyloxyethyl isocyanate or the like can be added within limits not detrimental to the chemical substance separation performance of the finally obtained organic polymer monolith.

### Non-Crosslinking Polymer

In one mode of the present invention, the throughpores can be formed by adding a substance, which continuously occupies a certain space without participating in the polymerization reaction, to the reaction system and using the substance as a template. A typical example of such a substance is a non-crosslinking polymer and is specifically a polymer not having a radical polymerizable functional group such as an ethylenic double bond. This method for forming throughpores exerts an effect especially when it is used in combination with the throughpore-forming method by adding the monomer having a hydroxyl group and/or an amide group (more preferably, by simultaneously using a diluent that comprises a compound (diluent) having none of a hydroxyl group, an amide group and a carboxyl group, in an amount of not less than 85% by mass based on the total amount of the diluent).

The non-crosslinking polymer is not specifically restricted, and examples thereof include polystyrene, polyethylene glycol and poly(N-isopropylacrylamide). Of these, polystyrene is preferably employed taking it into consideration that plural kinds of polymers having specific average molecular weights can be obtained relatively stably and polystyrene has excellent compatibility with the monomer mixture and the diluent in a system of a relatively wide range of hydrophobicity (medium level to high level).

The above non-crosslinking polymers may be used singly or in combination of plural kinds of different types or different average molecular weights.

It is not essential that the non-crosslinking polymer is dissolved in the monomer mixture or the diluent during the polymerization, and the polymerization may be allowed to proceed in such a state that fine droplets or fine particles of the non-crosslinking polymer are suspended or emulsified in another material. For example, in the case where the non-crosslinking polymer is poly(N-isopropylacrylamide), an aqueous solution of the poly(N-isopropylacrylamide) is emulsified in another material at a temperature of lower than 32° C. and then polymerization of the monomer mixture is carried out at a temperature of not lower than 32° C., whereby throughpores can be opened in the resulting polymer correspondingly to the sizes of micelles solidified, and the poly(N-isopropylacrylamide) can be readily removed by washing the polymer with water at a temperature of lower than 32° C. after the polymerization.

### Diluent

The diluent (also referred to as a “solvent”) for use in the invention is not specifically restricted provided that it can form a solution or a sufficiently homogeneous suspension together with the monomer mixture, a polymerization initiator and a non-crosslinking polymer that is added when needed. When many compounds having high polarity are contained in the monomer mixture, a polar solvent, such as N,N-dimethylformamide, 1-propanol or water, may be used singly or in combination with another solvent. For the purpose of allowing the shapes of throughpores of the organic monomer monolith to have regularity, a substance having orientation properties and self-accumulation properties, like liquid crystals, may be used as the diluent.

In the present invention, the monomer mixture comprising a monomer having a hydroxyl group and/or an amide group in an amount of not less than 20% by mass based on the total amount of the monomer mixture is employed. In the case where formation of throughpores is carried out without any aid of the non-crosslinking polymer, it is preferable to use a diluent that comprises a diluent (solvent) having none of a hydroxyl group, an amide group and a carboxyl group in an amount of not less than 85% by mass based on the total amount of the diluent in order not to diminish the effect of throughpore formation caused by the physical crosslinking due to hydrogen bonding.

As the solvent having none of a hydroxyl group, an amide group and a carboxyl group, toluene, ethylbenzene, xylene, diethylbenzene, chlorobenzene, dioxane, heptane, octane or isooctane is more preferable from the viewpoint of ease of obtaining, and toluene, ethylbenzene, xylene, diethylbenzene, chlorobenzene or dioxane is still more preferable from the viewpoint of compatibility with a (meth)acrylate type or styrene type monomer that is often used as a crosslinking agent and with non-crosslinking polystyrene that is often used as a non-crosslinking polymer. These solvents may be used singly or in combination of plural kinds.

In the case where the non-crosslinking polymer is not used and a solvent having a hydroxyl group, an amide group or a carboxyl group, such as methanol, water or acetic acid, is used, the amount of the solvent used needs to be less than 15% by mass based on the total amount of the diluent. If the amount thereof is not less than 15% by mass, physical crosslinking by the monomer having a hydroxyl group and/or an amide group is prevented, and formation of throughpores is not carried out sufficiently.

In the present invention, the presence of physical crosslinkage due to hydrogen bonding brought about by the combined use of the monomer having a hydroxyl group and/or an amide group and the diluent having none of a hydroxyl group, an amide group and a carboxyl group can be confirmed by, for example, a phenomenon that decay of an autocorrelation function delays, said phenomenon being found when the process of gelation of a polymer is observed by a dynamic light scattering method to monitor a relation between a scattering relaxation time and a scattering intensity as an autocorrelation function distribution, or a phenomenon that a part of absorption to which the hydroxyl group or the amide group is related is shifted to smaller wave numbers in a Fourier transform infrared absorption spectrum of the resulting monolith.

The proportion of the diluent for use in the invention is in the range of preferably 40 to 90% by mass, more preferably 50 to 85% by mass, still more preferably 60 to 80% by mass, based on the total amount of the monomer mixture, the diluent and the non-crosslinking polymer that is added when needed. If the proportion of the diluent is less than 40% by mass, volumes of throughpores of the monolith tend to become insufficient, and therefore, the burden of pressure in the passing of liquid tends to be increased. If the proportion thereof exceeds 90% by mass, volumes of throughpores tend to become too large, and the physical strength of the monolith tends to be decreased.

### Polymerization Initiator

Examples of the polymerization initiators for use in the invention include thermal polymerization initiators, photopolymerization initiators and redox polymerization initiators. Taking a wide application range into consideration, radical thermal polymerization initiators are preferable. Taking ease of obtaining into consideration, azo compounds, such as 2,2′-azobis(isobutyronitrile) and 2,2′-azobis(2,4-dimethylvaleronitrile), and organic peroxides, such as benzoyl peroxide, dichlorobenzoyl peroxide, dicumyl peroxide and lauroyl peroxide, are more preferable. Taking ease of handling into consideration, azo compounds, such as 2,2′-azobis(isobutyronitrile) and 2,2′-azobis(2,4-dimethylvaleronitrile), are still more preferable.

The proportion of the polymerization initiator is in the range of preferably 0.1 to 3 parts by mass, more preferably 0.1 to 2 parts by mass, still more preferably 0.2 to 1 part by mass, based on 100 parts by mass of the monomer mixture. If the proportion of the polymerization initiator is less than 0.1 part by mass, the time necessary for completion of the polymerization tends to become longer. If the proportion thereof is more than 3 parts by mass, throughpores tend to be not formed sufficiently, and the exotherm tends to be increased depending upon the scale.

### Polymerization Conditions

The temperature for carrying out the polymerization in the invention is not specifically restricted because the preferred temperature range varies depending upon difference in polymerization mechanism, such as thermal polymerization, photopolymerization or redox polymerization, but in case of, for example, thermal polymerization that is most frequently carried out, the temperature is in the range of preferably 40 to 100° C. Taking it into consideration that throughpores are readily formed sufficiently, the temperature is in the range of more preferably 45 to 80° C., still more preferably 50 to 70° C. If the temperature for carrying out the polymerization is lower than 40° C., the time necessary for completion of the polymerization tends to become longer. If the temperature is higher than 100° C., throughpores tend to be not formed sufficiently, and the exotherm tends to be increased depending upon the scale.

For the purpose of fine control of the pore structure, the temperature may be changed stepwise or continuously, if necessary. In case of photopolymerization or redox polymerization, the polymerization can be often completed without spending much time even if the temperature for carrying out the polymerization is lower than 40° C.

The time for carrying out the polymerization in the invention is not specifically restricted because the preferred range varies depending upon the polymerization mechanism, the type and the amount of the polymerization initiator, the polymerization temperature, etc., but in case of, for example, thermal polymerization that is most frequently carried out, the polymerization time is in the range of preferably 4 to 48 hours, more preferably 5 to 36 hours, still more preferably 6 to 24 hours, taking it into consideration that completion of polymerization is preferable to secure reproducibility and the working time should be in a practical range. If the polymerization time is less than 4 hours, the polymerization tends not to be completed, and hence, the polymer tends not to be sufficiently solidified or the reproducibility of polymerization tends not to be secured. If the polymerization time is longer than 48 hours, the production takes much time. In case of photopolymerization, however, the polymerization is often completed even if the polymerization time is less than 4 hours, and hence, there is a possibility of further shortening the polymerization time.

### Surface Modification of Organic Polymer Monolith

The organic polymer monolith of the invention can be subjected to surface modification, when needed. There is no specific limitation on the method of surface modification, and various methods heretofore used for the surface modification of particulate fillers are adoptable. For example, the surface modification is carried out by introducing a functional group or controlling hydrophobicity utilizing various means, such as reaction with a hydroxyl group or an oxirane ring on the monolith surface, graft reaction using a double bond remaining on the monolith surface, coating using adsorption on the monolith surface, and a combination thereof. The surface modification of the monolith using such means may be carried out by directly feeding a reagent for modification to a container in which the monolith has been formed or may be carried out by temporarily taking out the monolith from the container and bringing it into contact with a reagent for modification.

### Chemical Substance Separating Device

The chemical substance separating device of the invention uses the organic polymer monolith of the invention or the organic polymer monolith having been surface modified, and the form of the separating device is not specifically restricted. For example, there can be mentioned column, capillary, microchannel, cartridge, disc, filter and plate. The use application of the separating device is not specifically restricted either provided that the use application relates to separation of chemical substances. For example, there can be mentioned liquid chromatography, shear-driven chromatography, electrochromatography, electrophoresis, thin-layer chromatography, gas chromatography, chemical substance concentration and chemical substance removal.

The forms and the use applications mentioned above can be freely combined. However, taking into consideration effective utilization of the effects of the invention that the burden of pressure in the passing of liquid is light, separation of aromatic low-molecular compounds is favorably carried out, and solvent exchange can be freely carried out, more preferable are a column (including capillary type) for liquid chromatography, a microchannel for shear-driven chromatography, a plate for thin-layer chromatography, a column (or solid phase extraction cartridge) for chemical substance concentration and a column (or solid phase extraction cartridge) for chemical substance removal, and still more preferable are a column (including capillary type) for liquid chromatography, a column (or solid phase extraction cartridge) for chemical substance concentration and a column (or solid phase extraction cartridge) for chemical substance removal.

The chemical substance separating device of the invention may be one obtained by preparing the organic polymer monolith of the invention or the organic polymer monolith having been surface modified in a container (or channel) and finishing it as a separating device with keeping the shape of the monolith as it is, or may be one obtained by cutting the monolith together with the container (or channel) to an appropriate length and subjecting it to necessary treatments. Further, the chemical substance separating device may be one obtained by taking out the monolith from the container (or channel), then subjecting it to treatments such as cutting, crushing and surface modification when needed, and then filling or inserting the monolith in a different container (or channel), or may be one obtained by hardening the surface of the monolith with a resin to finish it as a separating device.

Preferred examples of the chemical substance separating devices of the invention include a capillary column for liquid chromatography obtained by preparing an organic polymer monolith in a fused silica capillary and then cutting the monolith to an appropriate length and a cartridge for chemical substance concentration obtained by preparing an organic polymer monolith in a polypropylene syringe tube and then fitting an outlet filter when needed, but the present invention is not limited thereto.

### EXAMPLES

The present invention is further described with reference to the following examples, but it should be construed that the invention is in no way limited to those examples.

### Example 1

### GDMA+Toluene; Observation of Gelation, Measurement of Pore Distribution and Specific Surface Area

A homogeneous mixture of glycerol dimethacrylate (GDMA, 2.0 g), toluene (2.0 g) and AIBN (10 mg) was transferred into a glass test tube (inner diameter 1.0 cm×length 20 cm) with filtering the mixture through a PTFE filter of 0.2 am, and then an argon gas was bubbled into the mixture for 10 minutes using a Pasteur pipette. Subsequently, an opening of the test tube was sealed with a cap and a Teflon® seal tape, and the test tube was immersed in a water bath (made of glass) at 60° C. to perform polymerization for 6 hours. During the polymerization, the state of the contents in the test tube was recorded by means of a CCD video camera to observe gelation. As a result, it was found that highly opaque gel layers were intermittently (stepwise) piled one upon another to form a pattern of horizontal stripes. A piece of the gel was washed with THF, then subjected to gold deposition and subjected to SEM observation (Hitachi S-3000N, 400 to 5,000 magnifications). As a result, a network structure wherein well-connected skeletons having a thickness of about 0.5 to 1 μm and well-connected throughpores between the skeletons, the distance of the skeletons being about 1 to 2 μm, were homogeneously dispersed in each other was confirmed.

A mode diameter of the throughpores, as measured by mercury porosimetry (Micrometrics PORESIZER 9320), was 2050 nm, and a mode diameter of the mesopores, as measured by a BET method (Micrometrics GEMINI II), was 9.08 nm. The specific surface area was 75.1 m²/g.

### Comparative Example 1a

### GDMA+Toluene+Methanol; Observation of Gelation, Measurement of Pore Distribution and Specific Surface Area

Polymerization, observation and measurement were carried out in the same manner as in Example 1, except that methanol (0.4 g) was added to the homogeneous mixture used in Example 1. In the observation of gelation, it was found that highly opaque gel layers were intermittently (stepwise) piled one upon another to form a pattern of horizontal stripes. The stripe pattern was observed more clearly than in Example 1. In the SEM observation, a structure wherein polymer spheres having diameters of about 5 to 10 μm were aggregated without any gap was found, and any throughpore was not observed at all.

In the mercury porosimetry (Micrometrics PORESIZER 9320), pores having a mode diameter of not less than 0.5 μm were not detected. A mode diameter of the mesopores, as measured by a BET method (Micrometrics GEMINI II), was 7.86 nm. The specific surface area was 176.8 m²/g.

### Comparative Example 1b

### EDMA+Toluene; Observation of Gelation, Measurement of Pore Distribution and Specific Surface Area

Polymerization, observation and measurement were carried out in the same manner as in Example 1, except that glycerol dimethacrylate (GDMA) was replaced with ethylene dimethacrylate (EDMA, 2.0 g). In the observation of gelation, it was found that a translucent gel layer was continuously produced and the upper surface of the gel rose smoothly. In the SEM observation, it was found that polymer continuums piled one upon another to form a wavy stripe pattern. Further, gaps like faults ranging to not less than 5 μm were found in places, but throughpores homogeneously dispersed were not observed.

In the mercury porosimetry (Micrometrics PORESIZER 9320), pores having a mode diameter of not less than 0.5 μm were not detected. A mode diameter of the mesopores, as measured by a BET method (Micrometrics GEMINI II), was 4.79 nm. The specific surface area was 266.3 m²/g.

### Comparative Example 1c

### HDMA+Toluene; Observation of Gelation, Measurement of Pore Distribution and Specific Surface Area

Polymerization, observation and measurement were carried out in the same manner as in Example 1, except that glycerol dimethacrylate (GDMA) was replaced with 1,6-hexanediol dimethacrylate (HDMA, 2.0 g). In the observation of gelation, it was found that an almost transparent gel layer was continuously produced and the upper surface of the gel rose smoothly. In the SEM observation, a non-porous continuum was found, and any throughpore was not observed at all.

In the mercury porosimetry (Micrometrics PORESIZER 9320), pores having a mode diameter of not less than 0.5 μm were not detected. A mode diameter of the mesopores was immeasurable by a BET method (Micrometrics GEMINI II). The specific surface area was 4.9 m²/g.

### Example 2

### GDMA+toluene; DLS Measurement at Gel Point

A homogeneous mixture of glycerol dimethacrylate (GDMA, 2.0 g), toluene (2.0 g) and AIBN (6 mg) was transferred into a glass test tube (inner diameter 1.0 cm×length 20 cm) with filtering the mixture through a PTFE filter of 0.2 μm, and then an argon gas was bubbled into the mixture for 10 minutes using a Pasteur pipette. Subsequently, an opening of the test tube was sealed with a cap and a Teflon® seal tape, and the gelation process in a water bath at 60° C. was observed by a dynamic light scattering method. In detail, a sample holder of a dynamic light scattering (DLS) device (manufactured by ALV-GmbH (Langen, Germany), ALV5000, He—Ne laser, output power: 22 mW, wavelength: 632.8 nm) was immersed in a water bath at 60° C., then the test tube was inserted into the sample holder, and a light scattering intensity at an angle of 90° to the incident light was continuously measured. The continuous data were taken out at intervals of 30 seconds and subjected to statistical analysis. A relation between a scattering relaxation time and a scattering intensity, said relation being examined every 30 seconds, was monitored with plotting the relation as an autocorrelation function distribution within the scattering relaxation time range of 10⁻⁴ ms to 10⁴ ms. As a result, it was found from the plot that at the time of gelation the autocorrelation function was high and 0.11 even at a relaxation time of 300 ms, and it was suggested that because of participation of hydrogen bonds, the intermolecular distance correlation was strengthened and physical crosslink density was increased.

### Comparative Example 2a

### GDMA+Toluene+Methanol; DLS Measurement at Gel Point

Polymerization and measurement were carried out in the same manner as in Example 2, except that methanol (0.4 g) was added to the homogeneous mixture used in Example 2. As a result, the autocorrelation function at a relaxation time of 300 ms was extremely small and 0.011, and it was suggested that participation of hydrogen bonds disappeared by the addition of methanol, whereby the intermolecular distance correlation was reduced and physical crosslink density was decreased.

### Comparative Example 2b

### EDMA+Toluene; DLS Measurement at Gel Point

Polymerization and measurement were carried out in the same manner as in Example 2, except that glycerol dimethacrylate (GDMA) was replaced with ethylene dimethacrylate (EDMA, 2.0 g). As a result, the autocorrelation function at a relaxation time of 300 ms was 0.084, which was smaller than the value of Example 2, and it was suggested the physical crosslink density was lower than that of Example 2.

### Comparative Example 2c

### HDMA+Toluene; DLS Measurement at Gel Point

Polymerization and measurement were carried out in the same manner as in Example 2, except that glycerol dimethacrylate (GDMA) was replaced with 1,6-hexanediol dimethacrylate (HDMA, 2.0 g). As a result, the autocorrelation function at a relaxation time of 300 ms was small and 0.025, and it was suggested the physical crosslink density was considerably low.

### Example 3

### GDMA 25%+EDMA 75% Monolith Capillary Column (Diluent: Toluene)

A nitrogen gas was bubbled into a homogeneous mixture of GDMA (1.0 g), EDMA (3.0 g), toluene (6.0 g) and AIBN (20 mg) for 15 minutes. A small amount of the mixture was filled in a polyimide coated fused silica capillary (inner diameter 200 μm×outer diameter 375 μm×length 800 mm) by means of a syringe pump. In detail, the mixture was fed at a rate of 20 μl/min for 5 minutes (100 μl), and then both ends of the capillary were sealed with a Teflon® seal tape. The center part (600 mm portion) of the capillary was immersed in a water bath at 60° C. to perform polymerization for 22 hours. The capillary was taken out of the water bath, and each end was cut by a length of 250 mm to obtain a monolith capillary column (inner diameter 200 μm×outer diameter 375 μm×length 300 mm).

One end of the column was inserted into a silica seal tight sleeve (manufactured by Upchurch Scientific, Inc., inner diameter: 395 μm, outer diameter: 1/16 inch, length: 40.6 mm) and was connected to a HPLC pump using a seal tight fitting, a ferrule and a union (manufactured by Upchurch Scientific, Inc.). After THF was passed through the column at a rate of 2.0 μl/min for 5 hours to wash the column, the column was disconnected from the HPLC pump. Then, the column was directly connected between an injector of a micro LC system (The Ultra-Plus II, manufactured by Micro-Tech Scientific Inc. (U.S.A.)) and an UV detector, followed by evaluation. For the connection, a silica seal tight sleeve, a seal tight fitting and a ferrule (manufactured by Upchurch Scientific, Inc.) were used. The evaluation conditions are as follows.

Mobile phase: acetonitrile/water (60/40 (v/v))

Flow rate: 2.0 μl/min

Injection volume: 0.10 μl (0.05 min automatic injecting from loop)

Sample: propylbenzene 200 ppm (dissolved in mobile phase)

Temperature: 40° C.

Detection: UV 254 nm (cell capacity: 0.25 μl, light path length: 2 mm)

As a result, the column pressure from which the system pressure of the device had been subtracted was 4.8 MPa, and the number of theoretical plates of propylbenzene was 4,500. The number of theoretical plates was calculated from the following formula using a retention time t_{R} and a width (W_{0.5}) at a half height of a peak in accordance with a half band width method.

Number of theoretical plates=5.54×(t_{R}/W_{0.5})²

A section of the capillary that had remained after cutting was subjected to gold deposition and then subjected to SEM observation. As a result, a network structure wherein polymer skeletons and throughpores were homogeneously dispersed in each other was confirmed.

### Comparative Example 3

### GDMA 100% Monolith Capillary Column (Diluent: Toluene)

A monolith capillary column (inner diameter 200 μm×outer diameter 375 μm×length 300 mm) was prepared in the same manner as in Example 3, except that the monomers (GDMA and EDMA) were replaced with EDMA (4.0 g). One end of the column was connected to a HPLC pump in the same manner as in Example 3. An attempt to wash with THF was made, but the column pressure exceeded 15 MPa even at a rate of 1.0 μl/min, and passing of liquid could not be carried out. A section of the capillary that had remained after cutting was subjected to gold deposition and then subjected to SEM observation. As a result, any throughpore was not observed at all.

### Example 4

### GDMA Monolith Capillary Column (Diluent (Chlorobenzene)+PS)

A nitrogen gas was bubbled into a homogeneous mixture of GDMA (4.0 g), chlorobenzene (5.7 g), polystyrene (0.3 g) having an average molecular weight of 250,000 and AIBN (20 mg) for 15 minutes. A small amount of the mixture was filled in a polyimide coated fused silica capillary (inner diameter 200 μm×outer diameter 375 μm×length 800 mm) by means of a syringe pump. In detail, the mixture was fed at a rate of 20 μl/min for 5 minutes (100 μl), and then both ends of the capillary were sealed with a Teflon® seal tape. The center part (600 mm portion) of the capillary was immersed in a water bath at 55° C. to perform polymerization for 22 hours. The capillary was taken out of the water bath, and each end was cut by a length of 250 mm to obtain a monolith capillary column (inner diameter 200 μm×outer diameter 375 μm×length 300 mm).

One end of the column was inserted into a silica seal tight sleeve (manufactured by Upchurch Scientific, Inc., inner diameter: 395 μm, outer diameter: 1/16 inch, length: 40.6 mm) and was connected to a HPLC pump using a seal tight fitting, a ferrule and a union (manufactured by Upchurch Scientific, Inc.). After THF was passed through the column at a rate of 3.0 μl/min for 3 hours to wash the column, the column was disconnected from the HPLC pump. Then, the column was directly connected between an injector of a micro LC system (The Ultra-Plus II, manufactured by Micro-Tech Scientific Inc. (U.S.A.)) and an UV detector, followed by evaluation. For the connection, a silica seal tight sleeve, a seal tight fitting and a ferrule (manufactured by Upchurch Scientific, Inc.) were used. The evaluation conditions are as follows.

Mobile phase: acetonitrile/water (60/40 (v/v))

Flow rate: 2.0 μl/min

Injection volume: 0.10 μl (0.05 min automatic injecting from loop)

Sample: propylbenzene 200 ppm (dissolved in mobile phase)

Temperature: 40° C.

Detection: UV 254 nm (cell capacity: 0.25 μl, light path length: 2 mm)

As a result, the column pressure from which the system pressure of the device had been subtracted was 2.9 MPa, and the number of theoretical plates of propylbenzene was 5,600. A section of the capillary that had remained after cutting was subjected to gold deposition and then subjected to SEM observation. As a result, a network structure wherein polymer skeletons and throughpores were homogeneously dispersed in each other was confirmed.

### Example 5

### EDMA Monolith Capillary Column (Diluent (Chlorobenzene)+PS)

A monolith capillary column (inner diameter 200 μm×outer diameter 375 μm×length 300 mm) was prepared in the same manner as in Example 4, except that GDMA was replaced with EDMA. One end of the column was connected to a HPLC pump in the same manner as in Example 4. After THF was passed through the column at a rate of 3.0 μl/min for 3 hours to wash the column, the column was disconnected from the HPLC pump. Then, the column was directly connected between an injector of a micro LC system (The Ultra-Plus II, manufactured by Micro-Tech Scientific Inc.) and an UV detector, followed by evaluation. The connection and the evaluation were carried out in the same manner as in Example 4.

As a result, the column pressure from which the system pressure of the device had been subtracted was 4.0 MPa, and the number of theoretical plates of propylbenzene was 2,900. A section of the capillary that had remained after cutting was subjected to gold deposition and then subjected to SEM observation. As a result, a network structure wherein polymer skeletons and throughpores were homogeneously dispersed in each other was confirmed.

### Example 6

### Surface Modification of GDMA Monolith Capillary Column

To one end of the monolith capillary column (inner diameter 200 μm×outer diameter 375 μm×length 300 mm) obtained in Example 4, a syringe pump was connected, and pyridine was passed through the column at a rate of 3.0 μl/min for 6 hours. Subsequently, a 2 wt % pyridine solution of butanoyl chloride was passed through the column at a rate of 0.1 μl/min for 12 hours. The column was disconnected from the syringe pump and then connected to a HPLC pump in the same manner as in Example 4. After methanol was passed through the column at a rate of 3.0 μl/min for 24 hours to wash the column, the column was disconnected from the HPLC pump. Then, the column was directly connected between an injector of a micro LC system (The Ultra-Plus II, manufactured by Micro-Tech Scientific Inc.) and an UV detector, followed by evaluation. The connection and the evaluation were carried out in the same manner as in Example 4.

As a result, the column pressure from which the system pressure of the device had been subtracted was 3.9 MPa, and the number of theoretical plates of propylbenzene was 3,400. The retention time of propylbenzene was 1.6 times the retention time of Example 4.

### Example 7

### GDMA+DVB Monolith Cartridge (Diluent (Toluene)+PS)

A nitrogen gas was bubbled into a homogeneous mixture of GDMA (4.8 g), m-divinylbenzene (DVB, 7.2 g), toluene (39.7 g), polystyrene (1.6 g) having an average molecular weight of 250,000 and AIBN (80 mg) for 15 minutes. Into a Teflon® tube having an inner diameter of 9.52 mm, an outer diameter of 12.7 mm and a length of 400 mm, whose lower end had been stoppered with a cap (obtained by cutting, at the center, a polypropylene syringe tube type empty cartridge having an inner diameter of 12.7 mm and closing an opening of narrower side), the mixture was poured up to a height of 350 mm from the lower end, and then the upper end of the Teflon® tube was stoppered with a cap (obtained by cutting, at the center, a polypropylene syringe tube type empty cartridge having an inner diameter of 12.7 mm and putting a connecting adapter in an opening of wider side to stopper the outlet). Subsequently, a part (from the lower end to a height of 300 mm) of the Teflon® tube was immersed in a water bath at 60° C. to perform polymerization for 24 hours. Then, the upper end cap was removed, and a small amount of the liquid remaining above was removed. Thereafter, the Teflon® tube with the contents (monolith) was cut into columns each having a length of 10 mm. As a result, the monolith easily came out from each column. The monolith having been air-dried had a diameter of 8.80 mm, and it was found that by the immersion in methanol the monolith swelled to have a diameter of up to 9.05 mm.

Subsequently, a few monoliths having clean sections were selected from the 3rd to 20th monoliths from the lower end, and they were each inserted into a polypropylene syringe tube type empty cartridge (equipped with a lower end frit) having a size of an inner diameter of 8.80 mm and a capacity of 3 ml, followed by equipping the cartridge with an upper end frit. Then, at the inlet of each cartridge, THF (20 ml), acetone/ethyl acetate (1/1, 10 ml), methanol (10 ml) and water (10 ml) were poured successively and allowed to free-fall to wash the monolith.

The cartridge filled with the monolith can be used as a solid phase extraction cartridge for chemical substance concentration or for chemical substance removal. For example, a total amount of a sample liquid obtained by adding 25 μl of a pesticide-mixed standard liquid (containing 300 ppm of methomyl (molecular weight: 162.2), 300 ppm of bendiocarb (molecular weight: 223.2) and 300 ppm of methiocarb (molecular weight: 225.3)) to 500 ml of pure water was passed through the cartridge at a rate of 10 ml/min by means of a diaphragm constant delivery pump. Then, elution with acetone/ethyl acetate (1/1, 10 ml), concentration by nitrogen gas spraying with heating to 30° C., dilution with acetonitrile until the volume was 3 ml, and HPLC analysis were carried out. As a result, excellent recoveries (methomyl: 99%, bendiocarb: 102%, methiocarb: 99%) were confirmed.

A piece of the gel monolith was washed with THF and then subjected to gold deposition, followed by SEM observation (500 magnifications). As a result, a network structure wherein skeletons of well-connected particulate units having diameters of about 5 to 10 μm and well-connected throughpores formed at a maximum distance between skeletons of about 10 to 20 μm were homogeneously dispersed in each other was confirmed.

### INDUSTRIAL APPLICABILITY

According to the present invention, an organic polymer monolith having a controlled pore structure and capable of efficiently separating chemical substances, particularly low-molecular chemical substances having a molecular weight of not more than 1,000, and a process for preparing the monolith can be provided. By the use of such an organic polymer monolith, there can be provided a chemical substance separating device, such as a column for liquid chromatography, a column for chemical substance concentration, a solid phase extraction cartridge for chemical substance concentration or a solid phase extraction cartridge for chemical substance removal, which has a light burden of pressure, is capable of favorably separating aromatic low-molecular compounds and is capable of freely carrying out solvent exchange.

1. An organic polymer monolith comprising a monomer unit derived from a monomer having a hydroxyl group and/or an amide group in an amount of not less than 20% by mass, having throughpores with a mode diameter, as measured by mercury porosimetry, of 0.5 to 10 μm and mesopores with a mode diameter, as measured by a BET method, of 2 to 50 nm, and having a specific surface area, as measured by a BET method, of not less than 50 m²/g.

2. An organic polymer monolith comprising a monomer unit derived from a crosslinking agent in an amount of not less than 50% by mass, having throughpores with a mode diameter, as measured by mercury porosimetry, of 0.5 to 10 μm and mesopores with a mode diameter, as measured by a BET method, of 2 to 50 nm, and having a specific surface area, as measured by a BET method, of not less than 50 m²/g.

3. The organic polymer monolith as claimed in claim 1, which is prepared by polymerizing a monomer mixture in the presence of a diluent and a polymerization initiator, wherein:
the monomer mixture comprises a crosslinking agent in an amount of not less than 50% by mass and a monomer having a hydroxyl group and/or an amide group in an amount of not less than 20% by mass, based on the total amount of the monomer mixture, and
the diluent comprises a diluent having none of a hydroxyl group, an amide group and a carboxyl group, in an amount of not less than 85% by mass based on the total amount of the diluent.

4. The organic polymer monolith as claimed in claim 1, which is prepared by polymerizing a monomer mixture in the presence of a diluent, a polymerization initiator and a non-crosslinking polymer, wherein:
the monomer mixture comprises a crosslinking agent in an amount of not less than 50% by mass and a monomer having a hydroxyl group and/or an amide group in an amount of not less than 20% by mass, based on the total amount of the monomer mixture.

5. The organic polymer monolith as claimed in claim 4, wherein the diluent comprises a diluent having none of a hydroxyl group, an amide group and a carboxyl group, in an amount of not less than 85% by mass based on the total amount of the diluent.

6. The organic polymer monolith as claimed in claim 4, wherein the non-crosslinking polymer is polystyrene.

7. The organic polymer monolith as claimed in claim 1, wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

8. The organic polymer monolith as claimed in claim 3, wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

9. The organic polymer monolith as claimed in claim 3, wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

10. The organic polymer monolith as claimed in claim 5, wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

11. A process for preparing the organic polymer monolith of claim 1, comprising a step of polymerizing a monomer mixture in the presence of a diluent and a polymerization initiator, wherein:
the monomer mixture comprises a crosslinking agent in an amount of not less than 50% by mass and a monomer having a hydroxyl group and/or an amide group in an amount of not less than 20% by mass, based on the total amount of the monomer mixture, and
the diluent comprises a diluent having none of a hydroxyl group, an amide group and a carboxyl group, in an amount of not less than 85% by mass based on the total amount of the diluent.

12. A process for preparing the organic polymer monolith of claim 1, comprising a step of polymerizing a monomer mixture in the presence of a diluent, a polymerization initiator and a non-crosslinking polymer, wherein:
the monomer mixture comprises a crosslinking agent in an amount of not less than 50% by mass and a monomer having a hydroxyl group and/or an amide group in an amount of not less than 20% by mass, based on the total amount of the monomer mixture.

13. The process as claimed in claim 12, wherein the diluent comprises a diluent having none of a hydroxyl group, an amide group and a carboxyl group, in an amount of not less than 85% by mass based on the total amount of the diluent.

14. The process as claimed in claim 12, wherein the non-crosslinking polymer is polystyrene.

15. The process as claimed in claim 11, wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

16. The process as claimed in claim 12, wherein the monomer having a hydroxyl group and/or an amide group is one or more monomers selected from the group consisting of glycerol dimethacrylate, 2-hydroxyethyl methacrylate, methylenebisacrylamide, N,N′-(1,2-dihydroxyethylene)bis-acrylamide, N-alkylacrylamide, N-vinylalkylamide, 4-(hydroxymethyl)styrene and 4-(acetamidomethyl)styrene.

17. The process as claimed in claim 11, wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

18. The process as claimed in claim 13, wherein the diluent having none of a hydroxyl group, an amide group and a carboxyl group is one or more compounds selected from the group consisting of toluene, ethylbenzene, xylene, diethylbenzene, chlorobenzene, dioxane, heptane, octane and isooctane.

19. A chemical substance separating device using, as a stationary phase, the organic polymer monolith of claim 1, or the organic polymer monolith having been surface modified.

20. The chemical substance separating device as claimed in claim 19, which is a column for liquid chromatography.

21. The chemical substance separating device as claimed in claim 19, which is a column for chemical substance concentration or a solid phase extraction cartridge for chemical substance concentration.

22. The chemical substance separating device as claimed in claim 19, which is a column for chemical substance removal or a solid phase extraction cartridge for chemical substance removal.
